(19) United States
(12) Patent Application Publication
(10) Pub. No.: US 2026/0349109 A1
(43) Pub. Date: Nov. 5, 2026

(54) RADAR IMAGING

(71) Applicant: Weibel Scientific A/S, Allerød (DK)

(72) Inventors: Rosanna IGNAZZI, Allerød (DK); Frederik Lindskov GAARDE, Allerød (DK)

(21) Appl. No.: 19/486,668

(22) PCT Filed: May 24, 2024
(86) PCT No.: PCT/DK2024/050124

§ 371 Date: Nov. 21, 2025

(30) Foreign Application Priority Data
May 25, 2023 (DK) PA2023 70253

(51) Int. Cl. G01S 13/90; G01S 13/58

(52) U.S. Cl. CPC G01S 13/9064; G01S 13/584

(57) ABSTRACT

A method of creating an inverse synthetic aperture radar, ISAR, image may include emitting a first radio signal towards one or more objects, receiving a first reflected radio signal resulting from the emitted first radio signal, emitting a plurality of second radio signals towards the one or more objects, receiving a plurality of second reflected radio signals resulting from the emitted second plurality of radio signals, processing the first reflected radio signal to estimate a velocity of the one or more objects, obtaining a plurality of distance measurement signals based on the plurality of second reflected radio signals, and ISAR processing the plurality of distance measurement signals. ISAR processing the plurality of distance measurement signals includes motion compensating the plurality of distance measurement signals using the velocity estimate obtained by processing the first reflected radio signal.

### TECHNICAL FIELD

The present disclosure relates to a method of creating an inverse synthetic aperture radar, ISAR, image, a radar processing device, and a radar system.

### BACKGROUND

To form a traditional radar image a plurality of radar antennas arranged in an array is required. Since the resulting resolution of the radar image is closely linked to the size of the radar array, larger radar arrays provide higher quality radar images.

Creating large arrays is however complex and expensive.

To improve the resolution Synthetic Aperture Radar, SAR, has been developed. SAR functions by moving the radar a distance over a time period e.g. using an air-plane, and recording radar signals during the time period. By combining the different radar signals a larger array may be synthetized resulting in improved resolution. This even allows radar imaging to be performed using a single radar antenna i.e., without using a radar array.

SAR can however not be used for stationary radars.

Instead, Inverse Synthetic Aperture Radar, ISAR, has been developed.

ISAR is an imaging technique similar to SAR, but instead of relying on movement of the radar, movement of the object to be imaged is relied on.

Thus, radar signals of the object to be imaged are recorded during a time period where the object moves relative to the radar and by combining the recorded radar signals a larger array may be synthetized.

Similar to SAR, ISAR allows radar imaging to be performed using a single radar antenna.

This enables improved radar imaging also for stationary radars.

Movement of the object is however typically not known to the radar system. In order to allow ISAR images to be formed, the movement is typically estimated using the recorded radar signals.

The resulting estimates of the movement are however often imprecise resulting in reduced image quality.

It therefore remains a problem to improve ISAR further.

### SUMMARY

According to a first aspect the disclosure relates to a method of creating an inverse synthetic aperture radar, ISAR, image, the method comprising, emitting a first radio signal towards one or more objects,
receiving a first reflected radio signal resulting from the emitted first radio signal,
emitting a plurality of second radio signals towards the one or more objects,
receiving a plurality of second reflected radio signals resulting from the emitted second plurality of radio signals,
processing the first reflected radio signal to estimate a velocity of the one or more objects,
obtaining a plurality of distance measurement signals based on the plurality of second reflected radio signals, and
ISAR processing the plurality of distance measurement signals, to create an ISAR image, wherein ISAR processing the plurality of distance measurement signals comprises motion compensating the plurality of distance measurement signals using the velocity estimate obtained by processing the first reflected radio signal.

Consequently, a method that enables ISAR images to be formed with improved image quality is provided. Having different types of radio signals used for ISAR imaging and motion compensation allows each type of radio signal to be optimized to its purpose. As an example, the first radio signal may be optimized for estimating motion of the one or more objects and the plurality of second radio signals may be optimized for estimating the distance to the one or more objects. This allows both precise motion compensation and high quality imaging.

A radio signal may be electromagnetic radiation of a frequency between 3 MHz and 110 GHz. Alternatively, the frequency of the radio signal may be between 1 GHZ and 100 GHz. The one or more objects may comprise an airborne object. The first reflected radio signal may result from the first radio signal being reflected by the one or more objects. The plurality of second reflected radio signals may result from the plurality of second radio signals being reflected by the one or more objects. The reflection may be a diffuse reflection. The frequency of the first or second radio signal may equal the frequency of the electric field in its electromagnetic wave. The first and second radio signal may refer to both an electromagnetic wave and to a corresponding signal before transmission or after reception. The first radio signal may be elliptically polarized or linearly polarized. The plurality of second radio signals may be elliptically polarized or linearly polarized.

The processing of the first reflected radio signal may provide a radial velocity estimate of the one or more objects in relation to the source of the first radio signal. The plurality of distance measurement signals may each indicate the distances to reflective points of the one or more objects.

The first radio signal may be emitted using a single radar antenna or a plurality of radar antennas arranged in an array. The first reflected radio signal may be received by a single radar antenna or a plurality of radar antennas arranged in an array. The antenna(s) used for emitting the first radio signal may also be used for receiving the first reflected radio signal. Alternatively, the antenna(s) used for emitting the first radio signal may be different from the antenna(s) used for receiving the first reflected radio signal.

Correspondingly, the plurality of second radio signals may be emitted using a single radar antenna or a plurality of radar antennas arranged in an array. The plurality of second reflected radio signals may be received by a single radar antenna or a plurality of radar antennas arranged in an array. The antenna(s) used for emitting the plurality of second radio signals may also be used for receiving the plurality of second reflected radio signals. Alternatively, the antenna(s) used for emitting the plurality of second radio signals may be different from the antenna(s) used for receiving the plurality of second reflected radio signals.

The antenna(s) used for emitting the first radio signal may be the same antenna(s) used for emitting the plurality of second radio signals. Alternatively, the antenna(s) used for emitting the first radio signal may be different from the antenna(s) used for emitting the plurality of second radio signals.

Correspondingly, the antenna(s) used for receiving the first reflected radio signal may be the same antenna(s) used for receiving the plurality of second reflected radio signals. Alternatively, the antenna(s) used for receiving the first reflected radio signal may be different from the antenna(s) used for receiving the plurality of second reflected radio signals.

Each of the plurality of second radio signals may be substantially identical. Each of the second plurality reflected radio signals may be processed to provide a distance measurement signal.

A distance measurement signal may represent estimated reflectiveness of the one or more objects at different distances to the radar.

Each of the plurality of second radio signals may be a pulsed radio signal with a relative short pulse. The distance measurement signals may then be obtained by estimating the time of flight of the short pulse. This may be done by directly sampling each of the plurality of second received reflected radio signals. Alternatively, analogue electronic components may be used to detect when the relative short pulse after reflection has returned.

In some embodiments, the plurality of second radio signals are frequency modulated continuous wave, FMCW, radio signals.

The FMCW signals may be a chirp signal. The frequency of the chirp signal may increase e.g. linearly or exponentially, with time until it reaches a predetermined end frequency after which the chirp signal ends. Alternatively, the frequency of a chirp signal may decreases e.g. linearly or exponentially, with time till it reaches a predetermined end frequency after which the chirp signal ends. To obtain the plurality of distance measurement signals each of the plurality of second reflected radio signal may be mixed with the emitted signal, i.e. a second radio signal. The mixer may either be implemented in hardware and/or software. The mixer may output a signal with frequencies matching the instantaneous frequency differences between the input signals.

The received first reflected radio signal may be directly sampled e.g. by an analogue to digital converter, ADC. Alternatively/additionally, the first reflected radio signal may be provided to the input of a mixer together with another signal e.g. the first radio signal wherein the output of the mixer is sampled by an ADC.

Each of the received plurality of second reflected radio signals may be provided to the input of a mixer together with its corresponding second radio signals wherein the output of the mixer is sampled by an ADC. Alternatively/additionally, the received plurality of second reflected radio signals may be directly sampled e.g. by an ADC.

The plurality of distance measurement signals may be motion compensated directly e.g. by shifting the plurality of distance measurement signals based on the estimated velocity of the one or more objects to take account of the movement of the one or more objects during the acquisition of the plurality of second reflected radio signals.

Alternatively, the plurality of distance measurements signals may be motion compensated indirectly by applying a varying phase shift to the plurality second reflected radio signal dependent on the estimated velocity of the one or more objects. If the plurality of second reflected radio signals are directly sampled, the phase shift may be applied electronically e.g. before they are processed to provide the plurality of distance measurement signals. Alternatively, if the second reflected radio signals are not directly sampled e.g. if only the output of a mixer provided with the second reflected radio signal is sampled, then the phase shift may be applied in real-time using an analogue variable phase shifter controlled based on the estimated velocity of the one or more objects.

The ISAR processing may comprise image reconstruction using well-known re-constructing techniques as described in [1]-[4] such as the range-Doppler (RD) techniques or the back-projection technique. The motion compensation may be done before performing image reconstruction e.g. a plurality of motion compensated distance measurement signals may be provided to the image reconstruction method. Alternatively, motion compensation may be done while performing the image reconstruction.

For image reconstruction one or more angles for each of the plurality of second reflected radio signals between the radar and the one or more objects are typically needed. Typically, a single angle enables a 2D image to be reconstructed and two angles enables a 3D image to be reconstructed. The angles may be estimated from the angles of a pedestal of the radar. Alternatively/additionally the angles may be derived by processing the plurality of second reflected radio signals and/or the first reflected radio signal.

In some embodiments, at least two antennas arranged in an array are used for receiving the first reflected radio signal, signals from the at least two antennas are processed together to estimate at least one angle between the one and more objects and the radar for each of the plurality of distance measurement signals resulting in a plurality of estimated angles, and wherein the plurality of distance measurements signals and the plurality of estimated angles are ISAR processed together to create the ISAR image.

Consequently, by using the first reflected radio signal the angle of arrival may be estimated with a high precision.

The angle may be found by estimating the phase difference between the at least two antennas. If more than two antennas are arranged in a two-dimensional array two angles may be estimated e.g. both the azimuth and the elevation angle may be found. If the first radio signal is a continuous wave, CW, signal with a constant frequency the phase difference may be estimated with a high precision, whereby the angle(s) may be estimated with a corresponding high precision. This may allow ISAR images to be formed with an improved image quality.

In some embodiments, the first radio signal and the plurality of second radio signals are emitted simultaneously.

Consequently the derived measurement signals from the first and the second radio signal may refer to the same point of time, enabling the combination of velocity and distance of the one or more objects at the same time. This may allow the motion compensation to become more precise.

In some embodiments, the method comprises emitting a plurality of first radio signals, and wherein the plurality of first radio signals and the plurality of second radio signals are sent sequentially.

This may provide a method with low interference between the first reflected radio signal and the second reflected radio signal.

In some embodiments, the first radio signal is a continuous wave, CW, radio signal comprising at least one constant frequency component.

The radial velocity of the one or more objects may result in a Doppler frequency shift on radio signals that are reflected by the one or more objects. The frequency shift is dependent on the radial velocity of the one or more objects at the time of the reflection. The first reflected radio signal may be processed to estimate the velocity of the one or more objects by comparing the frequency of the first reflected radio signal with the frequency of the first radio signal. The frequency difference may indicate the radial velocity of the one or more objects in relation to the source of the first radio signal. The CW radio signal may enable precise measurement of the velocity of the one or more objects in particular the radial velocity. The constant frequency component of the first radio signal may be the most prominent component of the signal. Using a CW signal may enable the velocity to be determined with a high precision since the frequency spectrum of the first reflected radio signal may be determined with a high frequency resolution.

As an example, if the plurality of second radio signals are FMCW signals, using a CW signal to estimate the velocity may result in more precise estimates of the velocity than if the velocity was estimated in the traditional manner using the FMCW signals. This may enable the precision of the ISAR motion compensation to be in-creased correspondingly, thereby resulting in ISAR image reconstruction with in-creased image quality.

In some embodiments, the processing of the first reflected radio signal to estimate the velocity of the one or more objects comprises analyzing the frequencies of the first reflected radio signal.

The frequencies of the first reflected radio signal may be analyzed by estimating the frequency spectrum of the first reflected radio signal or the frequency spectrum of another signal based on the first reflected radio signal e.g. the first reflected radio signal mixed with another signal e.g. mixed with the first radio signal. The frequencies may be analyzed by applying a DFT.

In some embodiments, the method further includes matching a frequency peak with the one or more objects, and wherein matching a frequency peak with the one or more objects comprises locating a frequency peak that is above a threshold value.

The threshold value may help to identify a peak that corresponds to the one or more objects, by distinguishing it over a base noise level. The threshold value may be a predetermined threshold value. The predetermined threshold value may advantageously be above a base noise level in order to discriminate frequency peaks from a base noise level. Alternatively, the threshold value may be determined by an algorithm based on operational conditions. These operational conditions may comprise a noise level of the first reflected radio signal or a distance of the one or more object.

In some embodiments, a plurality of spectra based on the first reflected radio signal are determined and wherein matching a frequency peak with the one or more objects comprises processing the plurality of spectra.

Consequently, the method may be able to distinguish the one or more objects in the plurality of spectra of the first reflected radio signal.

The plurality of spectra may be determined with a window function applied on the first reflected radio signal or another signal based on the first reflected radio signal e.g. the first reflected radio signal mixed with the first radio signal. Each spectrum of the plurality of spectra may originate from a different part of the first reflected radio signal. The processing of the plurality of spectra may comprise a linear quadratic estimation algorithm, such as a Kalman filter. The one or more objects may be matched to a frequency peak in each of the plurality of spectra of the first reflected radio signal. The frequency peaks that have been matched with the one or more object may have varying center frequencies, this may provide information of the radial velocity over time of the one or more objects.

In some embodiments, the step of matching a frequency peak with the one or more objects comprises processing at least two of the plurality of second reflected radio signals together with the first reflected radio signal.

This may allow a rough velocity estimate to be generated of the one or more objects using the at least two second reflected radio signals, that may be utilized to identify a frequency peak of the first reflected radio signal that corresponds to the velocity of the one or more objects. The identified frequency peaks may then be utilized to provide a more precise velocity estimate.

In some embodiments the first reflected radio signal is processed to estimate the velocity of the one or more objects at a plurality of distinct times resulting in a velocity function representing the velocity of the one or more objects as a function of time and wherein motion compensating the plurality of distance measurement signals comprises processing the velocity function.

Consequently, by using a velocity function, changes in the velocity of the one or more objects during the acquisition of plurality of second reflected radio signals may be accounted for, whereby the applied motion compensation may become more precise.

The first reflected radio signal may be processed to estimate the velocity of the one or more objects at a plurality of distinct times by applying window functions to the first reflected radio signal or another signal based on the first reflected radio signal e.g. the fist reflected radio signal mixed with the first radio signal. Each window function may result in a frame that is frequency analyzed e.g. using a DFT algorithm to provide a velocity estimate. The frames may be overlapping or non-overlapping.

The plurality of distance measurement signals may be motion compensated by numerically integrating the velocity function to determine the movement of the one or more objects during the acquisition of plurality of second reflected radio signals.

The velocity function may be a discrete function defined at plurality of distinct times. Alternatively/additionally, using interpolation and/or curve fitting methods the velocity function may be defined at any point in time.

In some embodiments, an initial range estimate of the one or more objects is made by processing at least one of the plurality of received second reflected radio signals, and wherein the initial range estimate together with the velocity function is processed to motion compensate the plurality of distance measurement signals.

Consequently, by additionally using an initial range estimate the motion compensation may become more precise.

The initial range estimate may be used to select a starting point for a numerical integration of the velocity function when determining the movement of the one or more objects. This may allow the precision of the motion compensation to be improved. The processing of the at least one received second reflected radio signal may be a combination of analogue processing and digital processing e.g. the at least one received second reflected radio signal may be analogue processed by an analogue mixer to provide a distance measurement signal. The distance measurement signal may then be sampled and digitally processed. The distance measurement signals may comprise a signal part resulting from reflections by the one or more objects. The signal part is typically sandwiched between a first and a second signal free part typically only containing background noise. The initial range estimate may be found by estimating a center of the signal part.

In some embodiments, the initial range estimate is based on a predetermined expected size of the one or more objects.

The expected size of the one or more objects may be used to select a suitable search filter e.g. a search filter having a filter kernel of a size approximately matching the expected size of the one or more objects. The search filter may be a one-dimensional filter operating on a single distance measurement signal or a two-dimensional filter operating on a plurality of distance measurement signals.

In some embodiments, the predetermined expected size is selected from a list comprising a plurality of predetermined expected sizes of different objects.

Furthermore, the initial range estimation of the one or more objects may be facilitated depending on what kind of object should be imaged. The sizes of different kind of objects may vary. The predetermined expected sizes may depend on the kind of object that is to be imaged.

In some embodiments, an acceleration function representing the acceleration of the one or more objects as a function of time is estimated based on the first reflected radio signal, wherein the velocity function together with the acceleration function is processed to motion compensate the plurality of distance measurement signals.

Consequently, by additionally using an acceleration function the movement of the one or more objects may more precisely be estimated, whereby the motion compensation may become correspondingly more precise.

After the velocity function of the one or more objects is estimated the acceleration function may be derived by numerical differentiation over time of the velocity function. The acceleration function may represent the radial acceleration of the one more objects.

In some embodiments, a jerk function representing the jerk of the one or more objects as a function of time is estimated based on the first reflected radio signal, wherein the velocity function together with the acceleration function and jerk function are processed to motion compensate the plurality of distance measurement signals.

Consequently, by additionally using a jerk function the movement of the one or more objects may more precisely be estimated, whereby the motion compensation may become correspondingly more precise.

After the velocity function of the one or more objects is estimated the jerk function may be derived by numerically differentiating the velocity function twice over time. Hence, the motion of the one or more objects may be described in even more detail and the motion compensation may be more precise as the time delay may be more precise.

According to a second aspect the present disclosure relates to a radar processing device for creating an ISAR image of one or more objects, the device comprising,
one or more processing units,
an input for receiving data,
wherein the one or more processing units are configured to:
receive a first reflected radio signal and a plurality of second reflected radio signals,
process the first reflected radio signal to estimate the velocity of the one or more objects,
obtain a plurality of distance measurement signals based on the plurality of second reflected radio signals, and
ISAR process the plurality of distance measurement signals, to create an ISAR image, wherein ISAR processing the plurality of distance measurement signals comprises motion compensating the plurality of distance measurement signals using the velocity estimate obtained by processing the first reflected radio signal.

Hence, a radar processing device that may enable precise and unambiguous radar imaging of non-cooperative objects is provided.

The one or more processing unit may receive radio signals via the input. The one or more processing unit may send an image to a device, such as a computer, a storage device, a server, or a display.

In some embodiments, the plurality of second radio signals are frequency modulated continuous wave, FMCW, radio signals.

In some embodiments, the first radio signal is a continuous wave, CW, radio signal comprising at least one constant frequency component.

In some embodiments, the one or more processing units are configured to analyzing the frequencies of the first reflected radio signal to estimate the velocity of the one or more objects.

In some embodiments, the one or more processing units are further configured to match a frequency peak with the one or more objects, and wherein matching a frequency peak with the one or more objects comprises locating a frequency peak that is above a threshold value.

In some embodiments, the one or more processing units are configured to determine a plurality of spectra based on the first reflected radio signal and wherein matching a frequency peak with the one or more objects comprises processing the plurality of spectra.

In some embodiments, the one or more processing units are configured to match a frequency peak with the one or more objects by processing at least two of the plurality of second reflected radio signals together with the first reflected radio signal.

In some embodiments, the one or more processing units are configured to process the first reflected radio signal to estimate the velocity of the one or more objects at a plurality of distinct times resulting in a velocity function representing the velocity of the one or more objects as a function of time and wherein motion compensating the plurality of distance measurement signals comprises processing the velocity function.

In some embodiments, the one or more processing units are configured to estimate an initial range of the one or more objects by processing at least one of the plurality of received second reflected radio signals, and wherein the initial range estimate together with the velocity function is processed to motion compensate the plurality of distance measurement signals.

In some embodiments, one or more processing units are configured to estimate the initial range based on a predetermined expected size of the one or more objects.

In some embodiments, the predetermined expected size is selected from a list comprising a plurality of predetermined expected sizes of different objects.

In some embodiments, the one or more processing units are configured to estimate an acceleration function representing the acceleration of the one or more objects as a function of time based on the first reflected radio signal, wherein the velocity function together with the acceleration function is processed to motion compensate the plurality of distance measurement signals.

In some embodiments, the one or more processing units are configured to estimate a jerk function representing the jerk of the one or more objects as a function of time based on the first reflected radio signal, wherein the velocity function together with the acceleration function and jerk function are processed to motion compensate the plurality of distance measurement signals.

According a third aspect the disclosure relates to a radar system, comprising a radar processing device according to the second aspect of the disclosure, at least one antenna, and a signal generating unit.

In some embodiments, the radar system comprises at least two antennas arranged in an array configured to receive the first reflected radio signal, the one or more processing units are configured to process signals from the at least two antennas together to estimate at least one angle between the one and more objects and the radar system for each of the plurality of distance measurement signals resulting in a plurality of estimated angles, and wherein the plurality of distance measurements signals and the plurality of estimated angles are ISAR processed together to create the ISAR image.

In some embodiments, the radar system is configured to emit the first radio signal and the plurality of second radio signals simultaneously.

In some embodiments, the radar system is configured to emit a plurality of first radio signals, and wherein the plurality of first radio signals and the plurality of second radio signals are sent sequentially.

The one or more processing unit of the image processing device may be any processing unit, such as a central processing unit (CPU), digital signal processing unit (DSP), a microcontroller unit (MCU), a field-programmable gate array (FPGA), or any combination thereof. The one or more processing unit may comprise one or more physical processors.

The different aspects of the present disclosure can be implemented in different ways including methods of creating an inverse synthetic aperture radar, ISAR, image, radar processing devices, and radar systems described above and in the following, each yielding one or more of the benefits and advantages described in connection with at least one of the aspects described above, and each having one or more preferred embodiments corresponding to the preferred embodiments described in connection with at least one of the aspects described above and/or disclosed in the dependent claims. Furthermore, it will be appreciated that embodiments described in connection with one of the aspects described herein may equally be applied to the other aspects.

### BRIEF DESCRIPTION OF THE DRAWINGS

In the following description embodiments of the present disclosure will be de-scribed with reference to the schematic drawings, in which

FIG. 1 shows a flowchart for a method of creating an ISAR image according to an embodiment of the disclosure.

FIG. 2 shows schematically a radar system 200 for creating an ISAR image of one or more objects according to an embodiment of the present disclosure.

FIG. 3a-b show a plurality of second radio signals 320 according an embodiment of the disclosure.

FIG. 4a-b show a first radio signal 410 according to an embodiment of the disclosure.

FIG. 5a-5h show simulation results obtained by simulating a radar system according to an embodiment of the disclosure.

### DETAILED DESCRIPTION

The person skilled in the art realizes that the present disclosure by no means is limited to the preferred embodiments described above. On the contrary, many modifications and variations are possible within the scope of the appended claims.

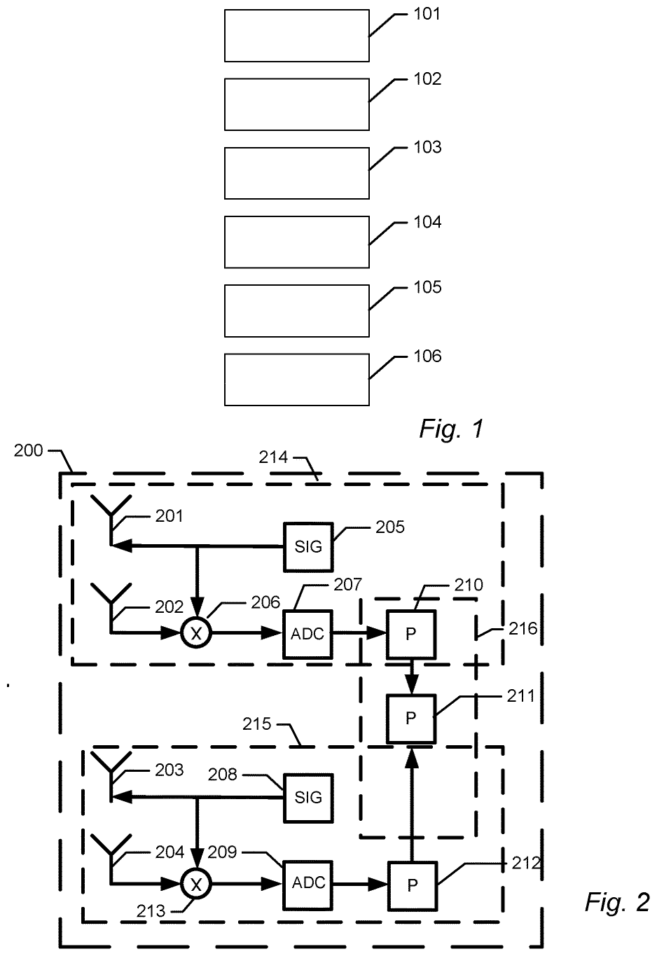

FIG. 1 shows a flowchart for a method of creating an ISAR image, according to an embodiment of the disclosure. The method comprises emitting a first radio signal towards one or more objects 101 and receiving a first reflected radio signal resulting from the emitted first radio signal 102. Emitting a plurality of second radio signals towards the one or more objects 103 and receiving a plurality of second reflected radio signals resulting from the emitted second plurality of radio signals 104. Processing the first reflected radio signal to estimate a velocity of the one or more objects 105. Obtaining a plurality of distance measurement signals based on the plurality of second reflected radio signals 105. ISAR processing the plurality of distance measurement signals 106, to create an ISAR image, wherein ISAR processing the plurality of distance measurement signals comprises motion compensating the plurality of distance measurement signals using the velocity estimate obtained by processing the first reflected radio signal.

FIG. 2 shows schematically a radar system 200 for creating an ISAR image of one or more objects according to an embodiment of the present disclosure. The radar system 200 comprises a first signal generator 205, a second signal generator 208, a first antenna 201, a second antenna 202, a third antenna 203, a fourth antenna 204, a first mixer 206, a second mixer 213, a first ADC 207, a second ADC 209 and a first processing unit 210, a second processing unit 211 and a third processing unit 212. The first signal generator 205 being communicatively coupled to the first antenna 201 and a first input of the first mixer 206. The second antenna being communicatively coupled to a second input of the first mixer 206, an output of the first mixer 206 being communicatively coupled to the input of the first ADC 207. The output of the first ADC 207 being communicatively coupled to an input of the first processing unit 210. The second signal generator 208 being communicatively coupled to the third antenna 203 and a first input of the second mixer 213. The fourth antenna 204 being communicatively coupled to a second input of the second mixer 213, an output of the second mixer 213 being communicatively coupled to the input of the second ADC 209. The output of the second ADC being communicatively coupled to an input of the third processing unit 212. The second processing unit 211 being communicatively coupled to the first processing unit 210 and the third processing unit 212.

The first antenna 201 is configured to emit a first radio signal towards one or more objects by receiving a first signal generated by the first signal generator 205. The second antenna 202 is configured to receive a first reflected radio signal resulting from the emitted first radio signal. In this embodiment, the first radio signal is a CW signal having a constant frequency component. The first reflected radio signal together with the first signal is mixed by mixer 206 to provide a first output signal with a frequency corresponding the frequency difference between the first signal provided by the first signal generator 205 and first reflected radio signal. The first output signal will have a frequency proportional to velocity of the one or more objects as a result of the Doppler effect. The first output signal is provided to the first ADC 207 for sampling. The output of the first ADC 207 is provided to the first processing unit 210. The first processing unit 210 is configured to process the output to estimate a velocity of the one or more objects e.g. by analyzing the frequencies of the output using an DFT. In this embodiment, the first reflected radio signal is processed by a combination of the first mixer 206 and the first processing unit 210 to estimate the velocity of the one or more objects. Thus a combination of analogue processing and digital processing is used to estimate the velocity of the one or more objects.

The elements within box 214 are a real base band implementation of a Doppler radar. However, a complex baseband implementation of the Doppler radar may also be used. In a complex baseband implementation, the first signal is phase shifted 90 degrees by a phase shifter and provided to the input of an additional mixer together with the first reflected radio signal. The output of the additional mixer is then provided to an additional ADC and the output of the additional ADC is provided to the first processing unit 210. A complex baseband implementation may improve SNR and make it easier to determine if the one or more objects are moving towards or away from the radar system 200.

The third antenna 203 is configured to emit a plurality of second radio signals towards the one or more objects by receiving a plurality of second signals generated by the second signal generator 208. The fourth antenna 204 is configured to receive a plurality of second reflected radio signals resulting from the emitted second plurality of radio signals. In this embodiment, each of the plurality of second radio signals is a frequency modulated continuous wave, FMCW, radio signal.

Each of the plurality of second reflected radio signals together with each of the plurality of second signals are mixed by the second mixer 213 to provide a plurality of second output signals, each of the plurality of second output signals has a frequency corresponding to the frequency difference between their input signals. The plurality of second output signals will have frequencies proportional to the distances of the one or more objects from the radar. The plurality of second output signals are provided to the second ADC 209 for sampling. The output of the second ADC 209 is provided to the third processing unit 212. The third processing unit 212 is configured to process each of the plurality of sampled second output signals to create a plurality of distance measurement signals that represent estimated reflectiveness of the one or more objects at different distances to the radar e.g. by analyzing the frequencies of the plurality of sampled second output signals using an DFT method. In this embodiment, the plurality of distance measurement signals are obtained by processing of the second mixer 213 and the third processing unit 212. Thus, a combination of analogue processing and digital processing is used to obtain the plurality of distance measurement signals.

The elements within box 215 is a real base band implementation of a FMCW radar. However, a complex baseband implementation of the FMCW radar may also be used. In a complex baseband implementation, the plurality of second signals are phase shifted 90 degrees by a phase shifter and provided to the input of an additional mixer together with the plurality of second reflected radio signals. The output of the additional mixer is then provided to an additional ADC and the output of the additional ADC is provided together with the output of the second ADC to the third processing unit 212. A complex baseband implementation may improve the SNR.

The first processing unit 210 is configured to provide the estimated velocity of the one or more objects to the second processing 211 and the third processing unit 212 is configured to provide the plurality of distance measurement signal to the third processing unit 211. The third processing unit 211 is configured to ISAR process the plurality of distance measurement signals, to create an ISAR image, wherein ISAR processing the plurality of distance measurement signals comprises motion compensating the plurality of distance measurement signals using the velocity estimate obtained by processing the first reflected radio signal.

In this embodiment three processing units 210-212 are used, however in other embodiments other number of processing units may be used e.g. a single processing unit 216 implementing the functionality of the three processing units 210-212.

If the first radio signal and the plurality of second radio signals are emitted simultaneously the radar system 214 may be configured to separate the reflected first radio signal from the plurality of reflected second radio signals. As an example, the first radio signal and the plurality of second radio signals may be separated in frequency. The second antenna 202 may be provided with one or more filters for filtering out the plurality of second reflected radio signal and substantially only passing on the first reflected radio signal to the first mixer 206. Correspondingly, the fourth antenna 204 may be provided with one or more filters for filtering out the first reflected radio signal and substantially only passing on the plurality of second reflected radio signals to the second mixer 213.

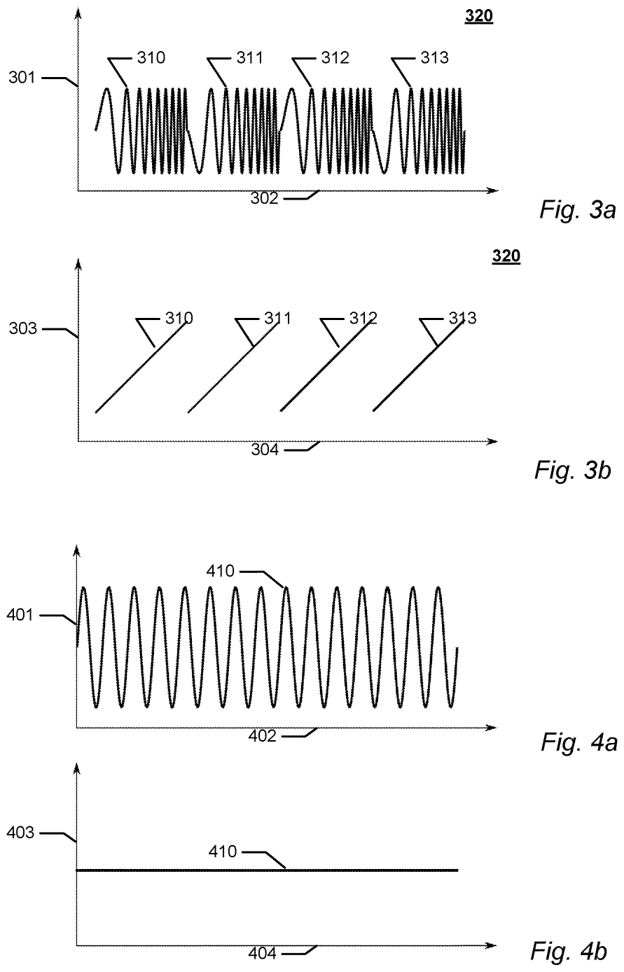

FIG. 3a-b show a plurality of second radio signals 320 according an embodiment of the present disclosure. FIG. 3a shows the amplitude of the plurality of second radio signals 320 as a function of time, where the axis 301 represent amplitude and the axis 302 represent time. FIG. 3b sows the frequency of the plurality of second radio signals 320 as a function of time, where the axis 303 represent frequency and the axis 304 represent time. The plurality of second radio signals 320 comprises a first signal 310, a second signal 311, a third signal 312, and a fourth signal 313. Each of the plurality of second radio signals 310-313 are substantially identical. In this embodiment, the plurality of second radio signals 310-313 are FMCW radio signals. The FMCW signals 310-313 are chirp signals. The frequency of the chirp signals increase linearly with time.

FIG. 4a-b show a first radio signal 410 according to an embodiment of the disclosure. FIG. 4a shows the amplitude of the first radio signal 410 as a function of time, where the axis 401 represent amplitude and the axis 402 represent time. FIG. 4b sows the frequency of the first radio signals 410 as a function of time, where the axis 403 represent frequency and the axis 404 represent time. The first radio signal is a CW radio signal comprising a constant frequency component.

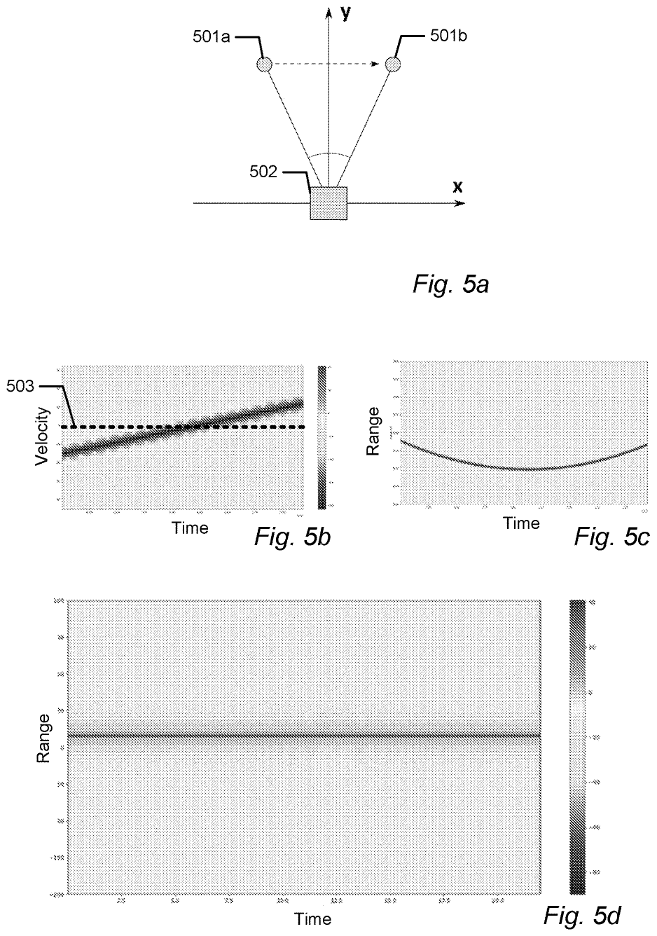

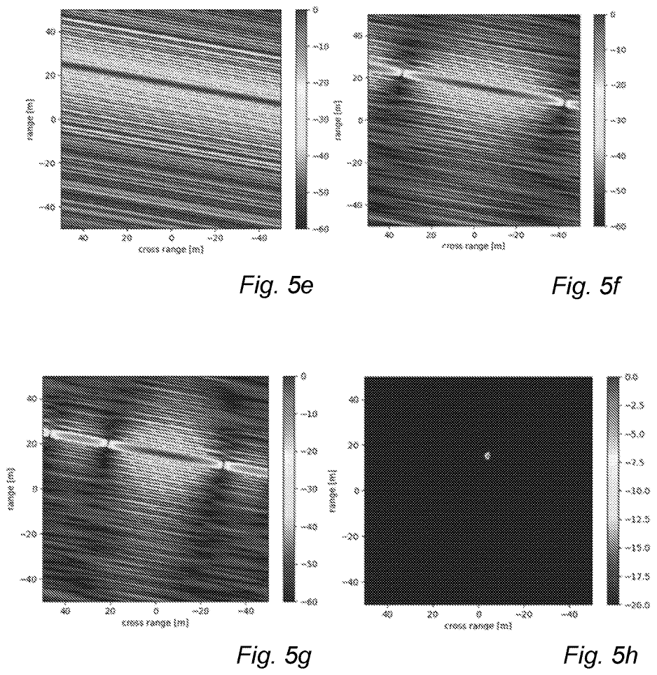

FIG. 5a-5h show simulation results obtained by simulating a radar system 502 as disclosed in relation to FIG. 2. FIG. 5a shows the simulated measurement setup. The radar system 502 is kept stationary and is emitting a first radio signal and a plurality of second radio signals towards an object 501. The object is moved along an X axis from a first position 501a to a second position 501b. For simplicity in this example, the object 501 is a point reflector.

A first reflected radio signal is received and processed to estimate the velocity of the object 501 at a plurality of distinct times. The result of the processing is shown in FIG. 5b. The first reflected radio signal is processed to estimate the velocity of the object at a plurality of distinct times by applying window functions to the fist reflected radio signal mixed with the first radio signal. Each window function result in a frame that is frequency analyzed using an DFT. Each column in FIG. 5b shows the amplitude spectrum of a frame. Each frequency in the amplitude spectrum correspond to a radial velocity (the velocity towards or away from the radar system 502). The line 503 shows the frequency corresponding to zero velocity. The object 501 will move towards the radar system 502 for the first half of the movement from position 501a to 501b and away from the radar system 502 for second half of the movement from position 501a to 501b.

FIG. 5c shows the resulting distance measurement signals before motion compensation, where each column is a single distance measurement signal.

FIG. 5d shows the result after the plurality of distance measurement signals have been motion compensated using velocity estimates obtained by processing the first reflected radio signal. In this example, each motion compensated distance measurement signal are identical since the reflectiveness of a point reflector is independent of the orientation between the reflector and the radar system 502. However, for more complex objects the motion compensated distance measurement signals will not be identical.

FIG. 5e-h illustrates how ISAR image reconstruction may be done using the plurality of motion compensated distance measurement signals. In this example, image reconstruction is done using the back projection technique. FIG. 5e shows an image after back projection of a single distance measurement signal, FIG. 5f shows an image after back projection of two distance measurement signals, FIG. 5g shows an image after back projection of three distance measurement signals, and FIG. 5h shows an image after back projection of all distance measurement signals.

Although some embodiments have been described and shown in de-tail, the present disclosure is not restricted to them, but may also be embodied in other ways within the scope of the subject matter defined in the following claims. In particular, it is to be understood that other embodiments may be utilized and structural and functional modifications may be made without departing from the scope of the present disclosure.

In device claims enumerating several means, several of these means can be embodied by one and the same item of hardware. The mere fact that certain measures are recited in mutually different dependent claims or de-scribed in different embodiments does not indicate that a combination of these measures cannot be used to ad-vantage.

It should be emphasized that the term “comprises/comprising” when used in this specification is taken to specify the presence of stated features, integers, steps or components but does not preclude the presence or addition of one or more other features, integers, steps, components or groups thereof.

### REFERENCES

[1] V. C. Chen and H. Ling, Time-Frequency Transforms for Radar Imaging and Signal Analysis. Norwood, MA, USA: Artech House, 2002.

[2] V. C. Chen and M. Martorella, Inverse Synthetic Aperture Radar Imaging: Principles, Algorithms and Applications. London, U.K.: Institution of Engineering and Technology, 2014.

[3] M. Martorella, “Introduction to inverse synthetic aperture radar,” in Academic Press Library in Signal Processing, vol. 2. Amsterdam, The Netherlands: Elsevier, 2014, pp. 9871042.

[4] R. Vehmas and N. Neuberger, “Inverse synthetic aperture radar imaging: A historical perspective and state-of-the-art survey”, IEEE Access, vol. 9, pp. 113917-113943, 2021.

1. A method of creating an inverse synthetic aperture radar, ISAR, image, the method comprising:
emitting a first radio signal towards one or more objects,
receiving a first reflected radio signal resulting from the emitted first radio signal,
emitting a plurality of second radio signals towards the one or more objects,
receiving a plurality of second reflected radio signals resulting from the emitted second plurality of radio signals,
processing the first reflected radio signal to estimate a velocity of the one or more objects,
obtaining a plurality of distance measurement signals based on the plurality of second reflected radio signals, and
ISAR processing the plurality of distance measurement signals, to create an ISAR image, wherein ISAR processing the plurality of distance measurement signals comprises motion compensating the plurality of distance measurement signals using the velocity estimate obtained by processing the first reflected radio signal.

2. The method according to claim 1, wherein the plurality of second radio signals are frequency modulated continuous wave, FMCW, radio signals.

3. The method according to claim 1, wherein the first radio signal is a continuous wave, CW, radio signal comprising at least one constant frequency component.

4. The method according to claim 1, wherein at least two antennas arranged in an array are used for receiving the first reflected radio signal, signals from the at least two antennas are processed together to estimate at least one angle between the one and more objects and the radar for each of the plurality of distance measurement signals resulting in a plurality of estimated angles, and wherein the plurality of distance measurements signals and the plurality of estimated angles are ISAR processed together to create the ISAR image.

5. The method according to claim 1, wherein the processing of the first reflected radio signal to estimate the velocity of the one or more objects comprises analyzing frequencies of the first reflected radio signal.

6. The method according to claim 1, wherein the first reflected radio signal is processed to estimate the velocity of the one or more objects at a plurality of distinct times resulting in a velocity function representing the velocity of the one or more objects as a function of time and wherein motion compensating the plurality of distance measurement signals comprises processing the velocity function.

7. The method according to claim 6, wherein an initial range estimate of the one or more objects is made by processing at least one of the plurality of received second reflected radio signals, and wherein the initial range estimate together with the velocity function is processed to motion compensate the plurality of distance measurement signals.

8. The method according to claim 6, wherein an acceleration function representing the acceleration of the one or more objects as a function of time is estimated based on the first reflected radio signal, wherein the velocity function together with the acceleration function is processed to motion compensate the plurality of distance measurement signals.

9. A radar processing device for creating an ISAR image of one or more objects, the device comprising,
one or more processing units,
an input for receiving data,
wherein the one or more processing units are configured to:
receive a first reflected radio signal and a plurality of second reflected radio signals,
process the first reflected radio signal to estimate the velocity of the one or more objects,
obtain a plurality of distance measurement signals based on the plurality of second reflected radio signals, and
ISAR process the plurality of distance measurement signals, to create an ISAR image, wherein ISAR processing the plurality of distance measurement signals comprises motion compensating the plurality of distance measurement signals using the velocity estimate obtained by processing the first reflected radio signal.

10. A radar system, comprising:
the radar processing device according to claim 9,
at least one antenna, and
a signal generator.
